(19) United States
(12) Patent Application Publication
(10) Pub. No.: US 2009/0268811 A1
(43) Pub. Date: Oct. 29, 2009

(54) Dynamic Image Reproducing Method And Device

(75) Inventor: Hajime Yoshimasu, Kanagawa (JP)

Correspondence Address: GIBSON & DERNIER L.L.P., 900 ROUTE 9 NORTH, SUITE 504, WOODBRIDGE, NJ, 07095, US

(73) Assignee: SONY COMPUTER ENTERTAINMENT INC., Tokyo (JP)

(21) Appl. No.: 12/441,481

(22) PCT Filed: Sep. 14, 2007
(86) PCT No.: PCT/JP2007/001005

§ 371 Date: May 19, 2009

(30) Foreign Application Priority Data
Sep. 19, 2006 (JP) 2006-252773

(51) Int. Cl. H04N 7/32

(52) U.S. Cl. 375/240.12; 375/E07.243

(57) ABSTRACT

A moving picture reproducing apparatus reproduces a moving picture file including different picture formats at a high speed. A parameter setting unit sets the number of frame α to be displayed per a unit time, a reproduction speed ratio β, a bit rate γ (α, β, and γ are real numbers). A seek distance setting unit sets a seek distance SD according to a value given by γ/α×β. An intra-frame encoded picture searching unit starts a search for a next intra-frame encoded picture at a search start position. A decoder decodes an intra-frame encoded picture found as a result of the search by the intra-frame encoded picture searching unit. The intra-frame encoded picture searching unit sets a data position ahead of a data position of the intra-frame encoded picture found by the seek distance, as a search start position to start searching for a next intra-frame encoded picture.

### BACKGROUND OF THE INVENTION

1. Field of the Invention

The present invention relates to a technology for reproducing moving pictures compression encoded in a format, a typical example of which is the Moving Picture Experts Group (MPEG) format. More particularly, the invention relates to a so-called trick play technology whereby moving pictures are fast-forwarded or fast-reversed.

2. Description of the Related Art

Recently, electronic devices such as personal computers, hard disk video recorders, Digital Versatile Disk (DVD) recorders, and game devices are provided with a recording device such as a hard disk device or a DVD device. Such a recording device is designed to record various moving pictures created or recorded by users.

Of these moving pictures, those encoded using a encoding scheme such as MPEG include different picture formats. Constraints from signal processing speed make it difficult to decode and display all frames (pictures) in case they are reproduced at, for example, a speed ten times higher than the normal speed. High-speed reproduction such as this would also create wasteful processes.

In one approach for high-speed reproduction of moving pictures, the picture format for pictures known as intra-frame encoded pictures (intra-pictures or I-pictures) spatially compressed in a format that does not depend on other pictures is extracted so that the intra-frame encoded pictures thus extracted are decoded and displayed.

Meanwhile, some moving picture files encoded in MPEG1 or MPEG2 are compressed in variable frame rates or variable bit rates with the result that intra-frame encoded pictures located at the start of respective Groups Of Pictures (GOP) may not be located at regular intervals and may be located one or more frames earlier or later than at the regular interval. If the position of intra-frame encoded pictures is recorded in association with the moving picture file, it will be possible to acquire the intra-frame encoded pictures by referring to the data. Meanwhile, if the data recording the position of intra-frame encoded pictures is absent, the moving picture reproducing apparatus should search for intra-frame encoded pictures on its own.

### SUMMARY OF THE INVENTION

The present invention addresses the above-described problem and one its purpose is to provide a moving picture reproducing method capable of searching for intra-frame encoded pictures efficiently and reproducing the pictures at a high speed.

According to at least one embodiment of the present invention, there is provided a moving picture reproducing method for reproducing a moving picture file including different picture formats. According to this method, when a given intra-frame encoded picture to be displayed is found, the position of an intra-frame encoded picture to be subsequently displayed is predicted so that a search for the intra-frame encoded picture to be subsequently displayed is started at the predicted position.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the structure of a moving picture reproducing apparatus according to a first embodiment;

FIG. 2 is a flowchart for high-speed reproduction performed by the moving picture reproducing apparatus of FIG. 1;

FIG. 3 is a time chart showing how an I-picture is searched for by the moving picture reproducing apparatus of FIG. 1;

FIG. 4 is a block diagram showing an exemplary structure of the moving picture reproducing apparatus according to a second embodiment; and

FIG. 5 is a flowchart for high-speed reproduction performed by the moving picture reproducing apparatus of FIG. 4.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

First, a summary of the moving picture reproducing method according to the embodiments will be given. The moving picture reproducing method according to the embodiments is adapted for high-speed reproduction of a moving picture encoded in a compression coding format such as MPEG.

The method according to one embodiment is adapted for high-speed reproduction of a moving picture file including different picture formats and comprises: updating, upon finding an intra-frame encoded picture to be displayed, a position at which to refer to data to a data position ahead of a current position by a data distance set up according to a value given by γ/α×β, starting a search for a next intra-frame encoded picture at the updated position at which to refer to data; and decoding the intra-frame encoded picture found as a result of the search, where α denotes the number of frames to be displayed per a unit time, β denotes a reproduction speed ratio, γ denotes a bit rate, and α, β, and γ are real numbers.

According to this embodiment, the position of occurrence of an intra-frame encoded picture is predicted using the number of frames α [fps], the reproduction speed ratio β [times], and the bit rate γ [bps]. When an intra-frame encoded picture is found, the position at which to refer to data is updated to a position displaced by the data distance before starting a search for a next intra-frame encoded picture. This eliminates the need to search for intra-frame encoded pictures within the distance jumped. As a result, intra-frame encoded pictures can be retrieved efficiently and high-speed reproduction is achieved. The term “reproduction” encompasses forward reproduction and backward reproduction. The term “jump to a data position ahead” means updating the data position in a direction of reproduction.

The reproducing method may also calculate the bit rate γ by dividing the size of the moving picture file to be reproduced by a reproduction time. The reproduction time may be an overall time required for reproduction and the size of a moving picture file may correspond to the overall reproduction time. Alternatively, the reproduction time may be a time required for reproduction of what remains to be reproduced starting at a current point of reproduction, and the size of a moving picture may correspond to the remaining reproduction time. According to this embodiment, the bit rate γ can be calculated easily.

The reproducing method may adaptively set up the number of frames α to be displayed per a unit time, in accordance with a search time required to search for one intra-frame encoded picture.

The reproducing method may calculate a search time by dividing a time elapsed since the start of reproduction by the number of intra-frame encoded pictures found hitherto.

When a time required to search for an intra-frame encoded picture is short, the number of intra-frame encoded pictures that can be found per a unit time is increased. Generally, the quality of moving pictures depends on the number of frames per a unit time. Therefore, by setting the number of frames in accordance with a search time, the best possible quality of high-speed reproduction can be ensured.

The data distance may be defined to be a value derived by multiplying γ/α×β by a constant smaller than 1. When the bit rate or frame rate is variable, the intra-frame encoded picture may be located before the data position at the destination of jump as defined by the data distance. By setting the data distance by multiplying γ/α×β by a constant smaller than 1, it is ensured that a search for an intra-frame encoded picture is started at a position slightly before the data position at the destination of jump defined by γ/α×β. Thereby, intra-frame encoded pictures can be found without fail.

Another embodiment relates to a moving picture reproducing apparatus adapted for high-speed reproduction of a moving picture file including different picture formats. The moving picture reproducing apparatus comprises a parameter setting unit operative to set the number of frames α to be displayed per a unit time, a reproduction speed ratio β, and a bit rate γ, where α, β, and γ are real numbers; a data distance setting unit operative to set a data distance according to a value given by γ/α×β; an intra-frame encoded picture searching unit operative to start a search for a next intra-frame encoded picture at a search start position; and a decoder operative to decode the intra-frame encoded picture found as a result of the search by the intra-frame encoded picture searching unit. The intra-frame encoded picture searching unit sets a data position ahead of a data position of a given intra-frame encoded picture found by the data distance, as a search start position to start searching for a next intra-frame encoded picture.

In yet another embodiment, there is provided a computer program product adapted for high-speed reproduction of a moving picture file including different picture formats. The program product comprises the modules for setting the number of frames α to be displayed per a unit time, a reproduction speed ratio β, and a bit rate γ, where α, β, and γ are real numbers; setting a data distance according to γ/α×β×k, where k denotes a real number satisfying 0<k≦1; jumping from a data position at which an intra-frame encoded picture is found to a data position ahead by the data distance; starting a search for a next intra-frame encoded picture at the data position at the destination of the jump; and decoding the intra-frame encoded picture found as a result of the search, wherein at least the setting of a data distance, the jumping, the starting, and the decoding are repeatedly executed by a computer.

Optional combinations of the aforementioned constituting elements, and implementations of the invention or the elements thereof in the form of methods, apparatuses, and systems may also be practiced as additional modes of the present invention.

A description will be given below, with reference to the drawings, of the high-speed moving picture reproducing method and apparatus according to the embodiments. In the figures, like numerals represent like constituting elements, members, and processes and the description thereof is omitted as appropriate. Reference herein to details of the illustrated embodiments is not intended to limit the scope of the claims. It should be understood that not all of the features and the combination thereof discussed are essential to the invention.

### FIRST EMBODIMENT

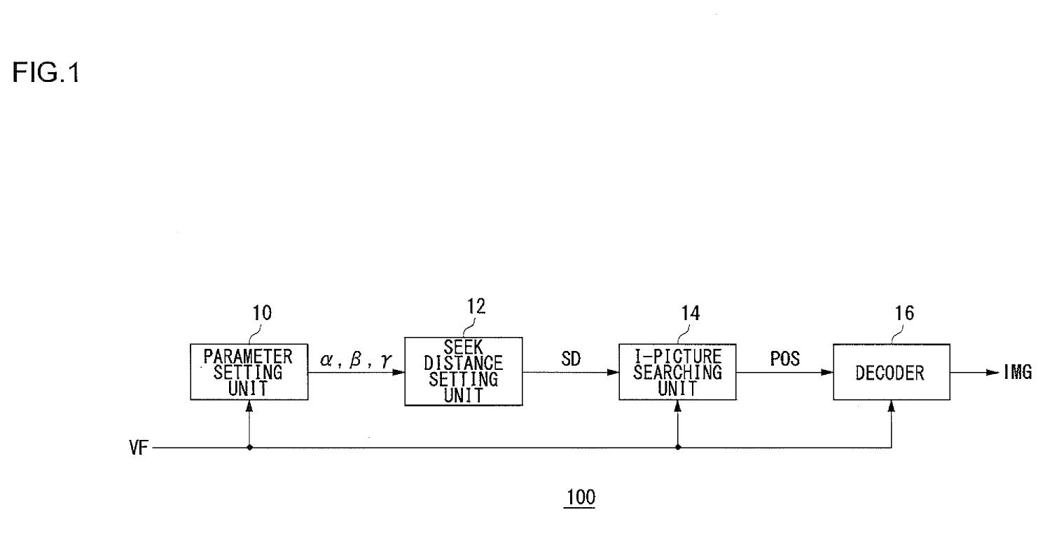

FIG. 1 is a block diagram showing a moving picture reproducing apparatus 100 according to the first embodiment. The moving picture reproducing apparatus 100 according to the first embodiment is installed in, for example, a device such as a personal computer, a DVD player, or a game device capable of reproducing moving pictures.

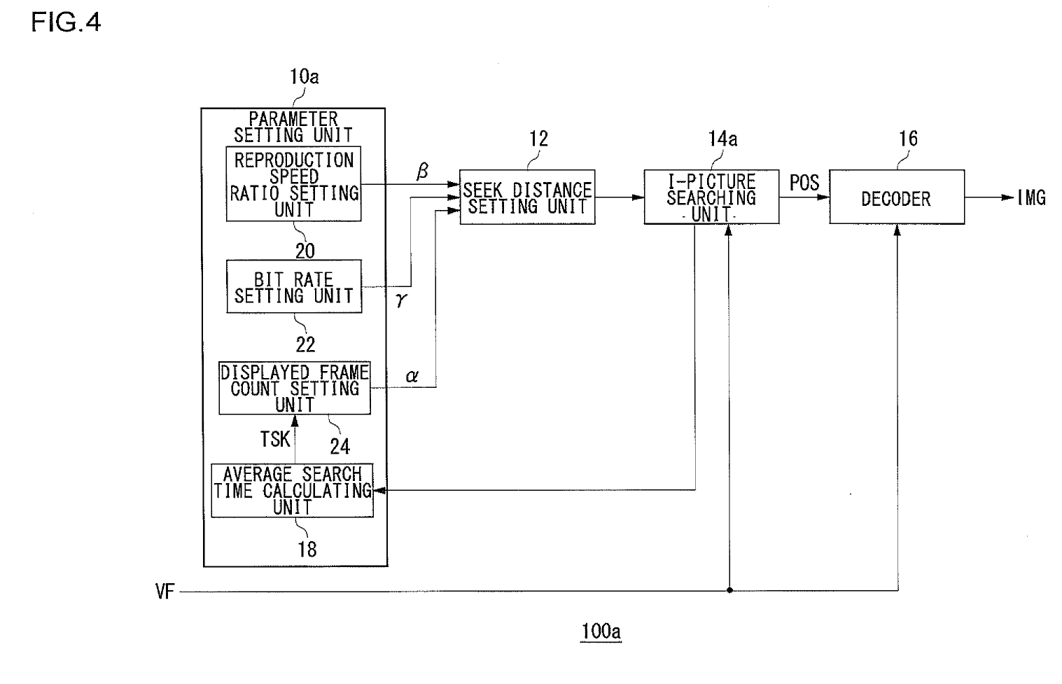

The elements illustrated in the figures as functional blocks and circuit blocks capable of performing respective functions may be implemented in hardware by a Central Processing Unit (CPU), a Digital Signal Processor (DSP), a memory, or Large Scale Integration. The elements may also be implemented in software by means of, for example, a program loaded into a memory. Therefore, it will be obvious to those skilled in the art that the functional blocks may be implemented in a variety of manners by hardware only, software only, or a combination of thereof. Therefore, the blocks shown in FIG. 1 and FIG. 4 mentioned later shall be understood as a constituting element of hardware, a processing module of a program, or a combination thereof.

The moving picture reproducing apparatus 100 reproduces a moving picture file VF (video file) encoded in a compression coding scheme such as MPEG. The moving picture file VF includes different picture formats and is recorded in a recording medium such as a hard disk, DVD, or memory. It will be assumed hereinafter that the picture file VF is encoded in MPEG. However, the present invention is not limited to a particular encoding scheme. The high-speed reproduction technology described hereinafter is effective for high-speed reproduction of a moving picture file in which the number of pictures in a GOP is not constant or the bit rate is variable. High-speed reproduction includes fast forwarding and fast reversing. The description below assumes that fast forwarding is performed.

An MPEG moving picture file is formed of a succession of GOPs. Each GOP is headed by an intra-frame encoded picture (hereinafter, simply referred to as I-picture), followed by a plurality of Predictive-Pictures (P pictures) or Bidirectional Pictures (B pictures). An I-picture is compressed by using only information within a single frame and does not use other temporally preceding or succeeding frames. The compression ratio of an I-picture is low but can be advantageously decoded without referring to other frames. A P-picture is compressed using information on correlation with a past frame. A B-picture is compressed using information on correlation with temporally preceding and succeeding frames. Since P-pictures and B-pictures require longer periods of time for decoding than I-pictures, I-pictures are primarily used for high-speed reproduction.

For high-speed reproduction, the moving picture reproducing apparatus 100 searches for I-pictures, which can be decoded independently, and decodes and displays the I-pictures retrieved by the search. The moving picture reproducing apparatus 100 is provided with a parameter setting unit 10, a seek distance setting unit 12, an I-picture searching unit 14, and a decoder 16.

During a high-speed reproduction, the parameter setting unit 10 sets the number of frames α [fps] to be displayed per a unit time (hereinafter, also referred to as displayed frame count), the reproduction speed ratio β [times] defined with respect to a normal speed, and the bit rate γ [bps], where α, β, and γ are real numbers. For example, the initial value of the displayed frame count α is 5 fps. The reproduction speed ratio β is set to, for example, twice, four times, eight times, fifty times, or one hundred times. The reproduction speed ratio β may be a constant preset in the moving picture reproducing apparatus 100 or freely set by the user of the moving picture reproducing apparatus 100.

The bit rate γ is calculated by analyzing the moving picture file VF. If the bit rate of the moving picture file VF is fixed, the value may be acquired by referring to the header information of the moving picture file VF and used accordingly. In the case of variable bit rate, the parameter setting unit 10 calculates the average value of bit rate γ (hereinafter, referred to as average bit rate) by dividing the size of a moving picture file to be reproduced by a reproduction time. For example, given that the file size is 3.6 GB (Byte) and the reproduction time is 60 minutes (=3600 seconds), the average bit rate γ is 8 Mbps.

The parameter setting unit 10 stores the parameters α, β, and γ thus set in a storage area such as a memory (hereinafter, simply referred to as memory).

The seek distance setting unit 12 sets a data distance (hereinafter, referred to as seek distance SD) determined by the frame count α [fps], the reproduction speed ratio β [times], and the bit rate γ [bps] set by the parameter setting unit 10. In the first embodiment, the seek distance setting unit 12 sets the seek distance SD such that SD=γ/α×β×k, where k denotes a constant that satisfies the relation k≦1. Acquisition of the parameters α, β, and γ is performed by referring to the memory. For example, given that the bit rate γ=8 Mbps, the displayed frame count α=5 (initial value), the reproduction speed ratio β=5, and the constant k=1, then, the seek distance SD=1 MB. The numerical value given by γ/α×β represents data predicting a data interval at which I-pictures to be displayed appear. The seek distance setting unit 12 writes the seek distance SD thus calculated in the memory. The above-described process of the seek distance setting unit 12 is implemented by arithmetic processing by a CPU or a DSP.

The seek distance setting unit 12 sets, as a search start position at which to start searching for the next intra-frame coded picture, the data position ahead of the data position of the I-picture previously identified by the I-picture searching unit 14 by the seek distance SD set as described above. Setting of a search start position is performed in a manner suitable for the recording device in which the moving picture file VF is recorded. For example, when the moving picture file VF is recorded on a hard disk or a DVD, the seek distance SD is designated for the disk controller, whereupon the disk controller moves the head to an area ahead of the current area by the seek distance SD. When the moving picture file VF is recorded on a memory, the memory controller is notified of an address to refer to that is ahead of the current address by the seek distance SD. Not all of the pictures in the moving picture file VF are necessarily stored in continuous address areas or sectors on a hard disk or a memory. Therefore, setting of a search start position by jumping the seek distance SD is performed in consideration of the address management scheme used by the moving picture reproducing apparatus 100 to manage the hard disk or memory.

The I-picture searching unit 14 starts searching for the next I-picture at the search start position set by the seek distance setting unit 12. Search for I-pictures is performed by referring to the header of the pictures. More specifically, the data for the moving picture file VF is scanned byte by byte. When the picture header of the target I-picture is found, the search is completed. The picture header may be searched for by pattern matching.

The I-picture searching unit 14 notifies the seek distance setting unit 12 of the data position of the I-picture thus found. The seek distance setting unit 12 uses the data position communicated from the I-picture searching unit 14 and the seek distance SD set, so as to calculate the position for the I-picture searching unit 14 to start the next search and notifies the I-picture searching unit 14 accordingly.

In this embodiment, the seek distance setting unit 12 sets the predetermined coefficient k to about 0.9. As a result, the I-picture searching unit 14 starts searching for the next I-picture at a position slightly preceding the predicted position, by multiplying the predicted interval of I-pictures to be displayed, given by γ/α×β, by a constant k smaller than 1. Given that γ=8 Mbps (1 MBps), α=5 fps, β=5 times, and k=0.9, then, the seek distance SD=900 kB.

The I-picture searching unit 14 successively scans a plurality of pictures forming the moving picture file VF, starting at the search start position, so as to find the target I-picture. When the I-picture searching unit 14 finds the target I-picture, the I-picture searching unit 14 outputs positional information POS indicating the position of the I-picture thus found to the decoder 16.

The decoder 16 refers to the positional information POS output from the I-picture searching unit 14 and decodes the I-picture found by the I-picture searching unit 14. The decoded image IMG is output to the processing block (not shown) in the subsequent stage. The processing block in the subsequent stage thins out the decoded image IMG as necessary or adjusts the timing for updating a frame buffer using the image IMG. The decoder 16 may be a CPU executing a decoding process according to a predetermined program or a DSP dedicated to the decoding process. The I-picture searching unit 14 may directly output the data for the I-picture found to the decoder 16 so that the decoder 16 decodes the data thus output.

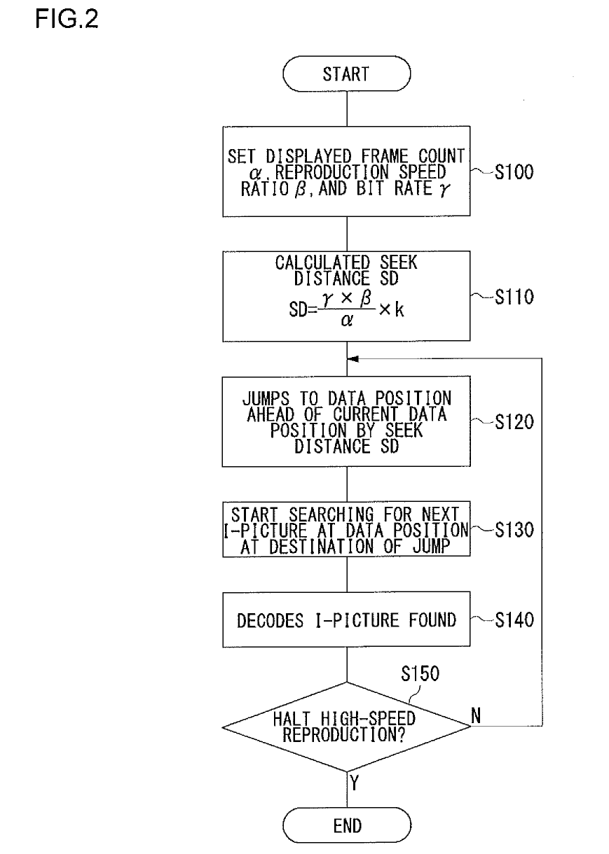

A description will now be given of the operation of the moving picture reproducing apparatus 100 with the above-mentioned structure. FIG. 2 is a flowchart for high-speed reproduction performed by the moving picture reproducing apparatus 100 of FIG. 1.

When the moving picture file VF to be reproduced at a high speed is specified, the parameter setting unit 10 sets the displayed frame count α, the reproduction speed ratio β, and the bit rate γ (S100). In the flowchart of FIG. 2, it is assumed that α, β, and γ once set are used permanently.

Subsequently, the seek distance setting unit 12 calculates the seek distance SD using α, β, and γ (S110). The I-picture searching unit 14 then jumps to the data position ahead of the data position currently referred to by the seek distance SD (S120). The unit 14 starts searching for the next I-picture at the data position at the destination of the jump (S130). If the I-picture to be subsequently displayed is found as a result of the search, the unit 14 decodes the I-picture thus found (S140). Thereafter, unless high-speed reproduction is halted (N in S150), control is returned to step S120, where the unit 14 jumps to the data position ahead of the current position by the seek distance SD (S120) so as to search for the next I-picture (S130). When high-speed reproduction is halted (Y in S150), the process is terminated.

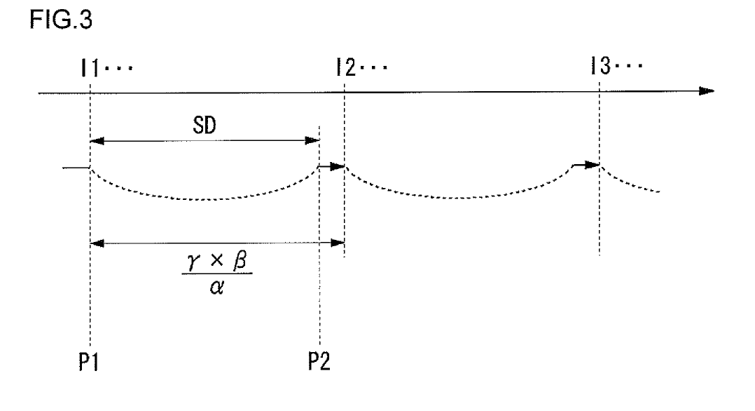

FIG. 3 is a time chart showing how an I-picture is searched for by the moving picture reproducing apparatus 100 of FIG. 1. The horizontal axis of FIG. 3 represents time t and at the same time corresponds to the address space of the recording device in which the moving picture file VF is recorded. Reference symbols I shown in FIG. 3 denotes I-pictures I1-I3 to be displayed in high-speed reproduction. A plurality of GOPs may be found between I-pictures shown and an I-picture may be found in each of the GOPs. However, FIG. 3 does not depict such details. In other words, FIG. 3 only shows I-pictures to be identified by a search.

When the I-picture I1 at a data position p1 is decoded and displayed, the search jumps to a data position p2 ahead of p1 by the seek distance SD. Referring to FIG. 3, a jump over the seek distance SD is indicated by a broken line. A search for the I-picture I2 to be subsequently displayed is started at the data position p2 at the destination of the jump. When the next I-picture I2 is found, the I-picture I2 thus found is decoded and displayed, whereupon the search jumps again to a data position P3 ahead of P2 by the seek distance SD.

Thus, the moving picture reproducing apparatus 100 according to the first embodiment allows efficient high-speed reproduction by using the displayed frame count α, the reproduction speed ratio β, and the bit rate γ to predict the position of occurrence of the I-picture to be displayed.

Without the use of the moving picture reproducing technology according to the first embodiment, display of a given I-picture should be followed by the step of referring to all GOPs sequentially. When the next I-picture to be displayed is found, the I-picture will then be decoded and displayed. An approach such as this will require a long period of time to search for an I-picture to be displayed. In contrast, the moving picture reproducing apparatus 100 according to the first embodiment performs a search only in the neighborhood of the I-picture to be displayed. Accordingly, time required for a search is reduced, the number of pictures that can be displayed per a unit time is increased, and the quality of a moving picture displayed at a high speed is improved.

### SECOND EMBODIMENT

The moving picture reproducing apparatus 100 according to the first embodiment searches for an I-picture, assuming that the displayed frame count α remains constant. The moving picture reproducing apparatus 100a according to the second embodiment is distinguished by a feature whereby high-speed reproduction is performed while the displayed frame count α is adaptively set.

The process performed in the moving picture reproducing method according to the second embodiment will be summarized as follows.

In the method of the second embodiment, a search time Tsk required to search for an I-picture to be displayed is recorded each time an I-picture is found. The search time is calculated by dividing an elapsed time Telp since the start of reproduction by the accumulated total number x of I-pictures found. In other words, Tsk=Telp/x. For example, given that the elapsed time Telp is 10s and the number of I-pictures found and decoded is such that x=100, the average search time Tsk will be 10/100=0.1 s. Hereinafter, the search time thus calculated will be referred to as average search time.

An average search time may be calculated without using the elapsed time since the start of reproduction and the accumulated total number of pictures found during the period. More specifically, a certain number x1 of previously found pictures may be identified and the search time may be calculated such that Telp1/x1, where Telp1 denotes a time required to find and decode x1 pictures. Alternatively, the search time may be calculated using a certain period of time Telp2 that elapses immediately before and the number of pictures x2 found and decoded during that period.

The elapsed time Telp denotes an actual period of time that elapses during high-speed reproduction and not a period of time represented by a moving picture reproduced at a high speed. For example, in double-speed reproduction lasting 10 seconds, the elapsed time Telp will be the 10 seconds on a real time axis instead of the 20 seconds covered by the moving picture reproduced at a high speed.

Subsequently, the moving picture reproducing method according to the second embodiment uses the average search time Tsk to calculate the number of I-pictures that can be found per second and defines the number thus calculated as the displayed frame count α. In other words, α≦1/Tsk. For example, given the average search time Tsk=0.1 s, the displayed frame count α is set at 1/0.1=10 at the maximum. The displayed frame count α may be set at a maximum integer that satisfies α≦1/Tsk or slightly smaller than the maximum integer thus defined.

Accordingly, the second embodiment calculates the average search time Tsk each time an I-picture is found and updates the displayed frame count α to an appropriate value. A description will now be given of the moving picture reproducing apparatus 100a that implements the method described above.

FIG. 4 is a block diagram showing an exemplary structure of the moving picture reproducing apparatus 100a according to the second embodiment. The following description will highlight the difference from the moving picture reproducing apparatus 100 of FIG. 1.

In the second embodiment, a parameter setting unit 10a adaptively sets the number of frames α to be displayed per a unit time, in accordance with the search time Tsk required to search for an I-picture. The parameter setting unit 10a includes an average search time calculating unit 18, a reproduction speed ratio setting unit 20, a bit rate setting unit 22, and a displayed frame count setting unit 24.

The reproduction speed ratio setting unit 20 sets the reproduction speed ratio β. The bit rate setting unit 22 calculates the bit rate γ. The reproduction speed ratio setting unit 20 and the bit rate setting unit 22 calculate and set β and γ in the same method described in connection with the parameter setting unit 10 of FIG. 1. The units 20 and 22 output the calculated values to the seek distance setting unit 12.

Each time the average search time calculating unit 18 is notified by the I-picture searching unit 14a that an I-picture is found, the unit 18 uses the accumulated number of I-pictures and the elapsed time Telp to calculate the average search time Tsk and notifies the displayed frame count setting unit 24 accordingly.

The average search time Tsk calculated by the average search time calculating unit 18 is communicated to the displayed frame count setting unit 24. The displayed frame count setting unit 24 sets the displayed frame count α by calculating 1/Tsk and outputs the count to the seek distance setting unit 12.

When the displayed frame count α is updated, the parameter setting unit 10a updates the seek distance SD according to the relation SD=γ/α×β×k. The seek distance setting unit 12 sets the position to start searching for an I-picture by using the seek distance SD calculated each time and communicates the position to the I-picture searching unit 14a. The I-picture searching unit 14a starts searching for an I-picture at the search start position thus communicated. Further, each time an I-picture is found, the I-picture searching unit 14a notifies the average search time calculating unit 18 accordingly.

The seek distance SD may be updated each time an I-picture is found or each time a predetermined number of I-pictures are found.

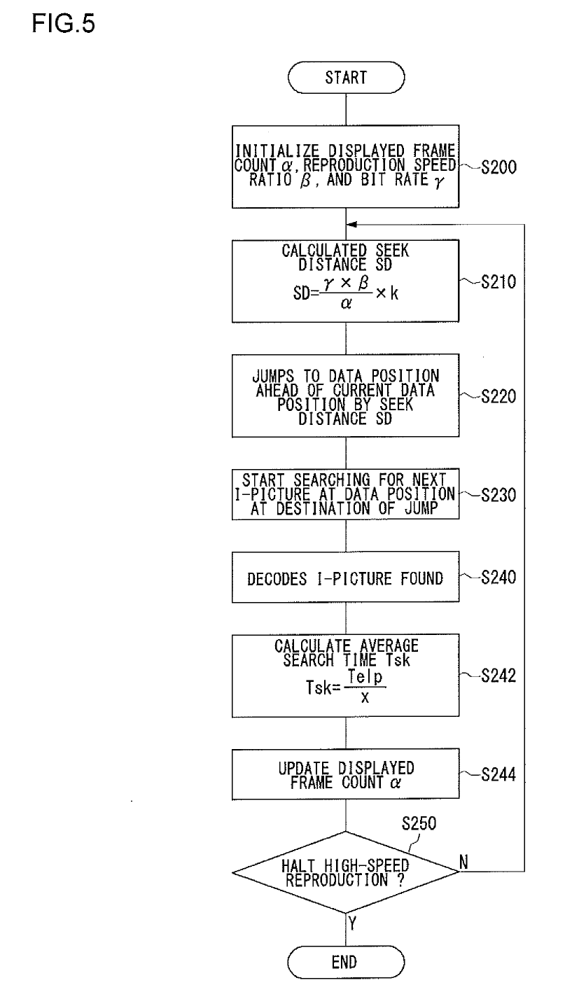

FIG. 5 is a flowchart for high-speed reproduction performed by the moving picture reproducing apparatus 100a of FIG. 4. The parameter setting unit 10a initializes the displayed frame count α, the reproduction speed ratio I, and the bit rate γ (S200). Initialization corresponds to step S100 of FIG. 2.

Subsequently, steps S210-S240 are sequentially performed in the moving picture reproducing apparatus 100a according to the second embodiment. Steps S210-S240 are identical with steps S110-S140 described with reference to FIG. 2.

Subsequently, the average search time calculating unit 18 calculates the average search time Tsk (S242). The displayed frame count setting unit 24 uses the average search time Tsk to update the displayed frame count α (S244). Subsequently, control is returned to step S210 unless high-speed reproduction is halted (N in S250). In step S210, the updated displayed frame count α is used to update the seek distance SD (S220). The search jumps to the data position ahead of the current position by the updated seek distance SD (S220), whereupon a search for the next I-picture is started (S230). When high-speed reproduction is halted (Y in S250), the process is terminated.

Thus, according to the moving picture reproducing apparatus 100a of the second embodiment, time required to search for an I-picture to be displayed is used to set an optimal displayed frame count α. As a result, when the search time becomes short, high-quality reproduction is achieved by increasing the number of frames displayed. When the search time becomes long, disruption of the process, e.g. failure of a decoding process to catch up with the display, can be prevented by reducing the number of frames displayed.

Given above is a description of the present invention based on the embodiments. The embodiment is intended to be illustrative only and it will be obvious to those skilled in the art that various modifications to constituting elements and processes could be developed and that such modifications are also within the scope of the present invention.

In the embodiments, the average bit rate γ is calculated, by way of example, by using the reproduction time of the moving picture file as a whole and the total file size. Alternatively, the reproduction time that remains while a moving picture file is being reproduced and the data size corresponding to the remaining reproduction time may be used. In this case, a more accurate bit rate γ will be obtained as the reproduction progresses. In case a moving picture file contains the data for bit rate for each GOP or for a plurality of GOPs, such data may be referred to.

While fast-forwarding is described in the embodiments by way of example, the present invention is equally applicable to fast-reversing. A time axis opposite in the direction will be assumed in this case. In other words, in a jump across a seek distance, the data position will be updated in a direction that goes back the reproduction time.

While the preferred embodiments of the present invention have been described using specific terms, such description is for illustrative purposes only, and it is to be understood that changes and variations may be made without departing from the spirit or scope of the appended claims.

1. A moving picture reproducing method adapted for high-speed reproduction of a moving picture file including different picture formats, comprising:
predicting, upon finding an intra-frame encoded picture to be displayed, a position of an intra-frame encoded picture to be subsequently displayed, and
starting a search for an intra-frame encoded picture to be subsequently displayed at the predicted position.

2. A moving picture reproducing method adapted for high-speed reproduction of a moving picture file including different picture formats, comprising:
updating, upon finding an intra-frame encoded picture to be displayed, a position at which to refer to data to a data position ahead of a current position by a data distance set up according to a value given by γ/α×β;
starting a search for a next intra-frame encoded picture at the updated position at which to refer to data; and
decoding the intra-frame encoded picture found as a result of the search, where α denotes the number of frames to be displayed per a unit time, β denotes a reproduction speed ratio, γ denotes a bit rate, and α, β, and γ are real numbers.

3. The method according to claim 2, further comprising:
calculating the bit rate γ by dividing the size of the moving picture file to be reproduced by a reproduction time.

4. The moving picture reproducing method according to claim 2, further comprising:
adaptively setting up the number of frames a to be displayed per a unit time, in accordance with a search time required to search for one intra-frame encoded picture.

5. The method according to claim 4, wherein the search time is calculated by dividing a time elapsed since the start of reproduction by the number of intra-frame encoded pictures found hitherto.

6. The moving picture reproducing method according to claim 2, wherein the data distance is defined to be a value derived by multiplying γ/α×β by a constant smaller than 1.

7. A moving picture reproducing apparatus adapted for high-speed reproduction of a moving picture file including different picture formats, comprising:
a parameter setting unit operative to set the number of frames α to be displayed per a unit time, a reproduction speed ratio β, and a bit rate γ, where α, β, and γ are real numbers;
a data distance setting unit operative to set a data distance according to a value given by γ/α×β;
an intra-frame encoded picture searching unit operative to start a search for a next intra-frame encoded picture at a search start position; and
a decoder operative to decode the intra-frame encoded picture found as a result of the search by the intra-frame encoded picture searching unit,
wherein the intra-frame encoded picture searching unit sets a data position ahead, by the data distance, of a data position of a given intra-frame encoded picture found, as a search start position to start searching for a next intra-frame encoded picture.

8. The moving picture reproducing apparatus according to claim 7, wherein the parameter setting unit sets the bit rate γ by dividing the size of the moving picture file to be reproduced by a reproduction time.

9. The moving picture reproducing apparatus according to claim 7, wherein the parameter setting unit adaptively sets up the number of frames α to be displayed per a unit time, in accordance with a search time required to search for one intra-frame encoded picture.

10. The moving picture reproducing apparatus according to claim 9, wherein the parameter setting unit calculates the search time by dividing a time elapsed since the start of reproduction by the number of intra-frame encoded pictures found hitherto.

11. The moving picture reproducing apparatus according to claim 7, wherein the parameter setting unit defines the data distance to be a value derived by multiplying γ/α×β by a constant smaller than 1.

12. A computer program product adapted for high-speed reproduction of a moving picture file including different picture formats, comprising the modules for:
setting the number of frames α to be displayed per a unit time, a reproduction speed ratio β, and a bit rate γ, where α, β, and γ are real numbers;
setting a data distance according to γ/α×β×k, where k denotes a real number satisfying 0<k≦1;
jumping from a data position at which an intra-frame encoded picture is found to a data position ahead by the data distance;
starting a search for a next intra-frame encoded picture at the data position at the destination of the jump; and
decoding the intra-frame encoded picture found as a result of the search, wherein
at least the setting of a data distance, the jumping, the starting, and the decoding are repeatedly executed by a computer.

13. A recording medium having embodied thereon the computer program product according to claim 12.
